(19) United States
(12) Patent Application Publication
(10) Pub. No.: US 2019/0206119 A1
(43) Pub. Date: Jul. 4, 2019

(54) MIXED REALITY DISPLAY DEVICE

(71) Applicant: CENTER OF HUMAN-CENTERED INTERACTION FOR COEXISTENCE, Seoul (KR)

(72) Inventors: Sang Hun Nam, Seoul (KR); Joung Huem Kwon, Seoul (KR); Younguk Kim, Seoul (KR); Bum Jae You, Seoul (KR)

(73) Assignee: CENTER OF HUMAN-CENTERED INTERACTION FOR COEXISTENCE, Seoul (KR)

(21) Appl. No.: 16/311,817

(22) PCT Filed: Jun. 12, 2017
(86) PCT No.: PCT/KR2017/006105

§ 371 Date: Dec. 20, 2018

(30) Foreign Application Priority Data
Jun. 30, 2016 (KR) 10-2016-0082974

(51) Int. Cl. G06T 15/40; G06T 19/00

(52) U.S. Cl. CPC G06T 15/405; G06T 19/006

(57) ABSTRACT

A mixed reality display device according to one embodiment of the present invention comprises: a virtual environment rendering unit for generating a virtual object by using information on a scene in a virtual reality, and then generating a color map and a depth map for the virtual object; a depth rendering unit for generating a depth map for a real object by using information on a real environment; an occlusion processing unit for performing occlusion processing by using the color map and the depth map, for the virtual object, received from the virtual environment rendering unit, the depth map, for a real object, received from the depth rendering unit, and a color map, for the real object, received from a see-through camera; and a display unit for outputting a color image by using a color map for the virtual object and a color map for the real object, which are received from the occlusion processing unit.

### TECHNICAL FIELD

Embodiments of the present invention generally relate to a mixed reality display device.

### BACKGROUND ART

A see-through camera is used to augment virtual objects in actual reality, whereby a user can see the reality in which real objects and virtual objects are mixed. In this case, when the virtual object is positioned behind the real object so that the real object covers the virtual object, the virtual object should not be visible in part or in whole.

The occlusion effect between the real object and the virtual object that causes the virtual object to be covered by the real object in part or in whole and thus to be not visible can be obtained by generating a depth map of the real object and a depth map of the virtual object respectively, comparing the depth map of the real object with the depth map of the virtual object on a per-pixel basis to select a pixel having a low depth, and displaying the same pixel color as the corresponding position in a color map.

The depth map and the color map of the virtual object can be obtained in the process of rendering the virtual object. However, there is a problem in that, in the case of the real object, the color map can be obtained through a see-through camera, but the depth map cannot be obtained by applying the existing method because there is no virtual model for the real object.

### DISCLOSURE

### Technical Problem

It is an object of the present invention to provide a mixed reality display device that generates a precise depth map for a real object and thus realizes an environment in which an actual environment and a virtual environment are mixed naturally.

In addition, an object of the present invention is to provide a mixed reality display device that is capable of being processed in one graphics device and being divided and processed into several graphics devices because a depth rendering engine and a virtual environment rendering engine are independently configured to have a pipeline structure.

The problems to be solved by the present invention are not limited to the above-mentioned problem(s), and another problem(s) not mentioned can be clearly understood by those skilled in the art from the following description.

### Technical Solution

In order to achieve the above-described object, the mixed reality display device according to the present invention includes: a virtual environment rendering unit generating a virtual object by using information on a scene in a virtual reality, and then generating a color map and a depth map of the virtual object; a depth rendering unit generating a depth map of a real object by using information on a real environment; an occlusion processing unit performing occlusion processing by using the color map and the depth map of the virtual object received from the virtual environment rendering unit, the depth map of the real object received from the depth rendering unit, and a color map of the real object received from a see-through camera; and a display unit outputting a color image by using the color map of the virtual object received from the occlusion processing unit and the color map of the real object received from the see-through camera.

The details of other embodiments are included in the detailed description and the accompanying drawings.

The advantages and/or features of the present invention and the manner of achieving them will become apparent with reference to the embodiments described in detail below with reference to the accompanying drawings. It should be appreciated, however, that the present invention is not limited to the embodiments disclosed herein but may be embodied in many different forms. Rather, these embodiments are provided such that this disclosure will be thorough and complete to fully disclose the scope of the invention to those skilled in the art. The invention is only defined by the scope of the claims. Like reference numerals refer to like elements throughout the specification.

### Advantageous Effects

According to the present invention, there is an advantage that it is possible to realize an environment in which an actual environment and a virtual environment are mixed naturally, by generating a precise depth map for a real object.

Further, according to the present invention, since the depth rendering engine and the virtual environment rendering engine are independently configured to have a pipeline structure, it is possible to provide a mixed reality display device that is capable of being processed in one graphics device and divided and processed into several graphics devices.

### DESCRIPTION OF DRAWINGS

FIG. 1 is a block diagram illustrating a mixed reality display device according to an embodiment of the present invention.

FIG. 2 is a block diagram illustrating a mixed reality display device according to another embodiment of the present invention.

FIGS. 3 to 5 are views illustrating an occlusion effect according to an embodiment of the present invention.

### MODE FOR INVENTION

Hereinafter, embodiments of the present invention will be described in detail with reference to the accompanying drawings.

As used herein, the term “depth map” is an image representing the depth of a real object or a virtual object as a pixel.

For example, when the first object is positioned behind a second object, the first object is deeper than the second object pixels, whereby a pixel for the first object will be assigned a larger depth value than a pixel for the second object. That is, a low depth value means that the corresponding object is close to the user, and a large depth value means that the corresponding object is far from the user.

As used herein, the term “color map” is an image representing the color of a real object or a virtual object as a pixel.

As used herein, the term “alpha map” is an image having a mask or alpha value for each pixel.

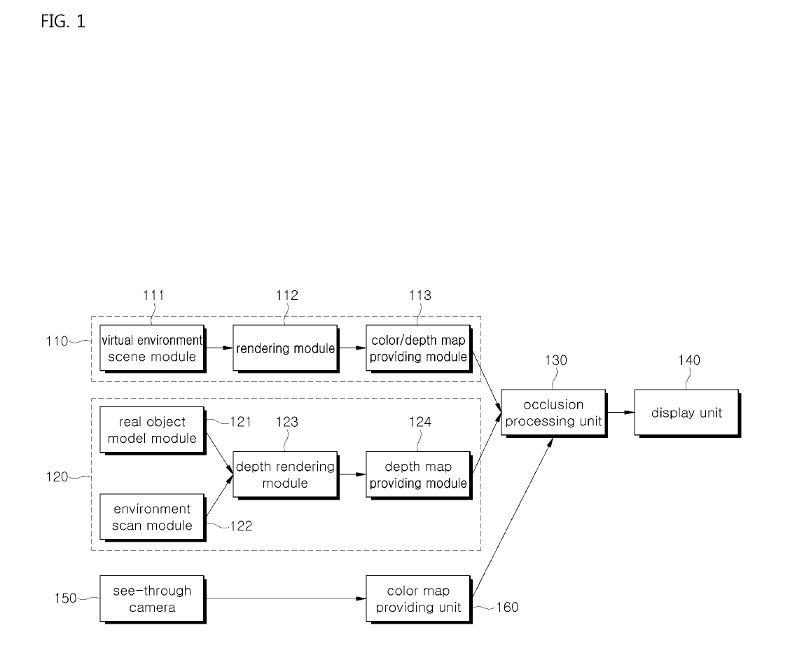

FIG. 1 is a block diagram illustrating a mixed reality display device according to an embodiment of the present invention.

Referring to FIG. 1, the mixed reality display device includes a virtual environment rendering unit 110, a depth rendering unit 120, an occlusion processing unit 130, a display unit 140, a see-through camera 150, and a color map providing unit 160.

The virtual environment rendering unit 110 creates a virtual object using information on a scene in a virtual reality, and then generates a color map and a depth map of the virtual object. The virtual environment rendering unit 110 includes a virtual environment scene module 111, a rendering module 112, and a color/depth map providing module 113.

The virtual environment scene module 111 provides a virtual environment configured with information about a virtual object.

The rendering module 112 performs rendering on the virtual environment provided by the virtual environment scene module 111 and generates a depth map and a color map for the virtual objects in the virtual environment during the rendering process.

The color/depth map providing module 113 provides the depth map and the color map generated by the rendering module 112 to the depth rendering unit 120.

The depth rendering unit 120 generates a depth map for a real object in a real environment using information on the real environment (i.e., a real object model). The depth rendering unit 120 is configured independently of the existing virtual environment rendering unit 110, and the entire graphics rendering unit has two independent pipeline structures.

Each of the depth rendering unit 120 and the virtual environment rendering unit 110 of the pipeline structure may be processed in one graphics device (for example, a GPU) and divided and processed into several graphics devices.

The depth rendering unit 120 includes a real object model module 121, an environment scan module 122, a depth rendering module 123, and a depth map providing module 124.

The real object model module 121 provides the depth-rendering module 123 with objects modeled in the same manner as real objects in the real environment.

The environment scan module 122 scans the real environment to generate a point cloud or a mesh model for the real object. The point cloud and the mesh model are used when the depth rendering is performed by the depth rendering module 123 to generate the depth map. This description will be described in more detail with respect to the depth rendering module 123.

The point cloud is a collection of points in a three-dimensional coordinate system that describes a three-dimensional scene, in which the points in the point cloud represent the outer surfaces of objects.

The mesh model is a closed structure that includes faces, nodes, and edges. For example, the mesh may be formed of a triangle, and formed of a polygon such as a rectangle or a pentagon.

Given the size or area of such mesh, the mesh may be automatically generated from tens to thousands and tens of thousands depending on the modeled shape, and such mesh generation may be performed by a technique that has been already known in the field of modeling a three-dimensional shape.

The depth rendering module 123 performs depth rendering to generate the depth map using the real object model received from the real object model module 121 or the mesh model or point cloud received from the environment scan module 122.

In one embodiment, the depth rendering module 123 configures the same scene as the real environment using the object modeled in the same manner as the real object received from the real object model module 121, and generates the depth map using the scene in real time.

In the above embodiment, when a type of the real object is a dynamic object, the depth rendering module 123 tracks and predicts the position and rotation of the dynamic object using the information received from the environment scan module 122, to change the position and rotation in the depth rendering dynamically.

Accordingly, the depth rendering module 123 may directly simulate the real environment by tracking and predicting the position and rotation of the object to change the position and rotation in the depth rendering dynamically, even when the type of the real object is the dynamic object.

In another embodiment, the depth rendering module 123 maps each point of the point cloud received from the environment scan module 122 to a pixel on the display, thereby generating a depth map.

As described above, the depth rendering module 123 performs the depth rendering to generate the depth map immediately when the point cloud is received from the environment scan module 122, when performing the depth rendering.

When the depth rendering module 123 does not perform the depth rendering immediately when the point cloud is received from the environment scan module 122 but performs the depth rendering after a certain time, the depth map generated by depth rendering is not accurate.

This is because the real objects of the actual environment scanned by the environment scan module 122 may be changed. Accordingly, the depth rendering module 123 performs the depth rendering immediately when the point cloud is received from the environment scan module 122 to generate the depth map.

The depth map providing module 124 provides the occlusion processing unit 130 with the depth map generated through the depth rendering in the depth rendering module 123.

The occlusion processing unit 130 receives the depth map and the color map of the virtual object received from the color/depth map providing module 113 of the virtual environment rendering unit 110, the depth map of the real object received from the depth map providing module 124 of the depth rendering unit 120, and a color map of the real object received from the see-through camera 150.

More specifically, the occlusion processing unit 130 compares the depth map of the real object with the depth map of the virtual object on a per-pixel basis, and determines that the real object does not cover the virtual object when a pixel has the same depth, and the real object is covering the virtual object when a pixel has a different depth.

This is possible because when the real object does not cover the virtual object, the real object is separated from the virtual object so that the depth map is created with the same depth value being assigned. Meanwhile, when the real object covers the virtual object, the virtual object is positioned behind the real object so that the depth value of the virtual object at the corresponding pixel is assigned larger than the depth value of the real object.

Accordingly, the occlusion processing unit 130 selects a pixel having a lower depth value and displays the same pixel color as the corresponding position in the color map of the real object when a pixel has a different depth, as a result of comparing the depth map of the real object with the depth map of the virtual object on a per-pixel basis.

In other words, when the virtual object is positioned behind the real object so that the real object covers the virtual object, since the depth value in the depth map of the real object is lower than the depth value of the virtual object for a pixel of the covered area, the corresponding pixel is selected in the depth map of the real object and then a color of the same pixel in the color map of the real object is output through the display unit 140.

In this case, since the same pixel color is displayed in the color map of the real object and the color of the corresponding pixel in the color map of the virtual object is not displayed, the virtual object is invisible in part or in whole when the virtual object is positioned behind the real object so that the real object covers the virtual object.

The see-through camera 150 allows a user to view a real object through one or more partially transparent pixels that display the virtual object. The see-through camera 150 provides the real object in the real environment through a color map providing unit 160 to the occluded processing unit 130.

There is a problem in that, in the case of the real object, the color map can be obtained through a see-through camera, but the depth map cannot be obtained by applying the existing method because there is no virtual model for the real object. Meanwhile, since the depth map rendering unit 120 generates a precise depth map according to the present invention, it is possible to realize an environment in which the real environment and the virtual environment are mixed naturally.

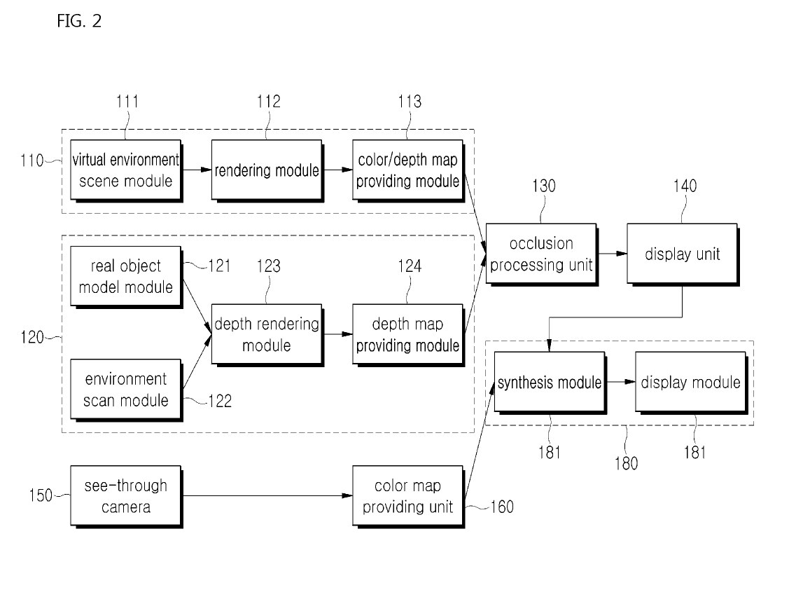

FIG. 2 is a block diagram illustrating a mixed reality display device according to another embodiment of the present invention. FIG. 2 relates to an embodiment in which a real object is independently implemented by using an FPGA for processing an occlusion effect that causes the virtual object to be covered by the real object and thus to be invisible in part or in whole.

Referring to FIG. 2, the mixed reality display device includes a virtual environment rendering unit 110, a depth rendering unit 120, an occlusion processing unit 130, a see-through camera 150, a color map providing unit 160, and a synthesis processing unit 180. Since the virtual environment rendering unit 110 and the depth rendering unit 120 have been described with reference to FIG. 1, a detailed description thereof will be omitted.

The occlusion processing unit 130 generates an alpha map by using the depth map and color map of the virtual object received from the color/depth map providing module 124 of the virtual environment rendering unit 110, the depth map of the real object received from the depth map providing module 124 of the depth rendering unit 120, and a color map of the real object received from the see-through camera 150. Here, the alpha map means an image having a mask or alpha value for each pixel.

In the embodiment of FIG. 1, the occlusion processing unit 130 process an occlusion effect between the real object and the virtual object by comparing the depth map of the real object with the depth map of the virtual object on a per-pixel basis, and selecting a low depth value and displaying the same pixel color as the corresponding position in the color map of the real object when a pixel has a different depth value as a result of comparison.

Unlike the embodiment of FIG. 1, the occlusion processing unit 130 of FIG. 2 does not perform the occlusion processing as in FIG. 1, but generates an alpha map having a mask or alpha value for processing the occlusion effect.

This alpha map is referred when a synthesis module 181 described below outputs at least one of the pixel in the color map of the real object and the pixel in the color map of the virtual object. This process will be described in more detail in the following synthesis module 181.

The occlusion processing unit 130 provides the alpha map and the color map of the virtual object to the synthesis module 181 of the synthesis processing unit 180.

The synthesis processing unit 180 uses the color map of the virtual object in the virtual reality and the alpha map received from the color map providing unit 160 and the color map of the real object received from the see-through camera 150.

The synthesis module 181 uses the alpha map to output at least one of the pixel of the color map of the virtual object and the pixel of the color map of the real object received from the see-through camera 150 through the display module 182, depending on whether a particular pixel is in mask format or alpha format.

In one embodiment, the synthesis module 181 outputs the pixel in the color map of the real object received from the see-through camera 150 or the pixel in the color map of the virtual object, depending on whether the mask is 0 or 1 when a specific pixel format is a mask format in the alpha map.

In the above embodiment, the synthesis module 181 outputs the pixel of the color map of the real object received from the see-through camera 150 through the display module 182 when the mask value is 0. Accordingly, the pixel in the color map of the virtual object is covered and the pixel in the color map of the real object received from the see-through camera 150 is output.

On the other hand, the synthesis module 181 outputs the pixel in the color map of the virtual object through the display module 182 when a pixel format is a mask format in the alpha map and the mask value is 1. Accordingly, the pixel in the color map of the real object received from the see-through camera 150 is covered and the pixel in the color map of the virtual object is output.

In another embodiment, the synthesis module 181 performs blending calculations on the pixel of the color map of the real object received from the camera and the pixel of the color map of the virtual object according to the alpha value when a specific pixel format is an alpha format in the alpha map, to output the pixel of the color map of the real object and the pixel of the color map of the virtual object.

The reason that the present invention uses the alpha value is because a transparency may be determined when the pixel in the color map of the real object are output together with the pixel in the color map of the virtual object.

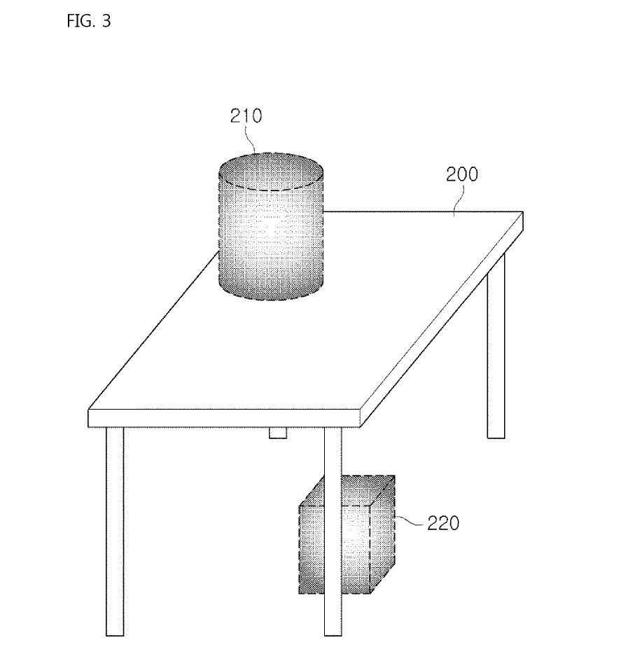

FIGS. 3 to 5 are views showing an occlusion effect according to an embodiment of the present invention.

Referring to FIGS. 3 to 5, it is possible to see a reality in which a real object and a virtual object are mixed by augmenting the virtual object using a see-through camera in an actual reality. In this case, when the virtual object is positioned behind the real object so that the real object covers the virtual object, the virtual object should not be visible in part or in whole.

As shown in FIG. 3, it is possible to see a reality in which a desk 200 of a real object and a cylinder 210 and a cube body 220 of virtual objects are mixed by augmenting the cylinder 210 and the cube body 220 of the virtual objects using a see-through camera in the actual reality. In this case, when the cube body 220 of virtual objects is positioned behind the desk 200 of the real object so that the desk 200 of the real object covers the cube body 220 of the virtual object, the cube 220 of the virtual object should be invisible in part.

To this end, the mixed reality display device generates a depth map of the desk 200 of the real object and a depth map of the cube 220 of the virtual object, compares the depth map of the desk 200 of the real object with the depth map of the cube 220 of the virtual object on a per-pixel basis to select a pixel having a lower depth value, displays the same pixel color as the corresponding position in the color map of the desk 200 of the real object, thereby allowing a part of the cube 220 of the virtual object to be covered by the desk 200 of the real object and thus invisible.

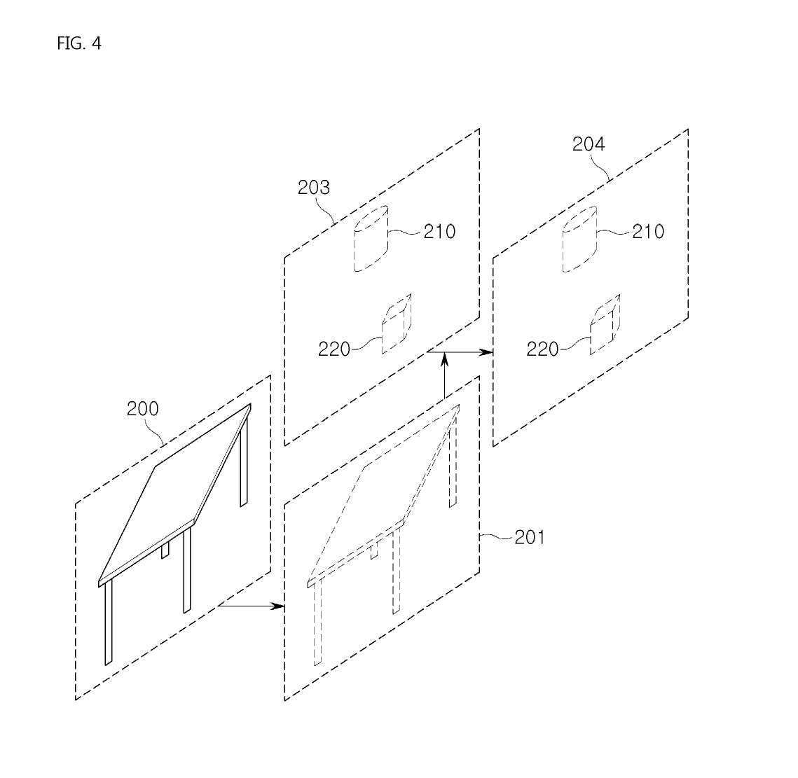

As shown in FIG. 4, the mixed reality display device compares the depth map 201 of the desk 200 of the real object with the depth map 203 of the cylinder 210 and the cube 220 of the virtual objects on a per-pixel basis, whereby it is determined that that the desk 200 of the real object does not cover the cube 220 of the virtual object when a desk pixel has a larger depth value and the desk 200 of the real object covers the cube 220 of the virtual object when a desk pixel has a lower depth value.

The reason for this is that when the desk 200 of the real object does not cover the cube 220 of the virtual object, the real object is closer to a user so that a lower depth value is allocated when generating the depth map, and when the desk 200 of the real object covers the cube 220 of the virtual object, the cube 220 of the virtual object is positioned behind the desk 200 of the real object so that the depth value of the cube 220 of the virtual object in the corresponding pixel is assigned larger than the depth value of the desk 200 of the real object.

Accordingly, the mixed reality display device selects the pixel in the depth map of the desk 200 of the real object and displays the same pixel color as the corresponding position in the color map of the desk 200 of the real object, since the depth value in the depth map of the desk 200 of the real object is lower, as a result of comparing the depth map of the desk 200 of the real object with the depth map of the cube 220 of the virtual object on a per-pixel basis.

More specifically, when the cube 220 of the virtual object is positioned behind the desk 200 of the real object so that the desk 200 of the real object covers the cube 220 of the virtual object, the depth value in the depth map of the desk 200 of the real object is lower than depth value of the cube 220 of the virtual object for a pixel of the covered area, whereby the corresponding pixel is selected from the depth map of the desk 200 of the real object and then the color of the same pixel in the color map of the desk 200 of the real object is output.

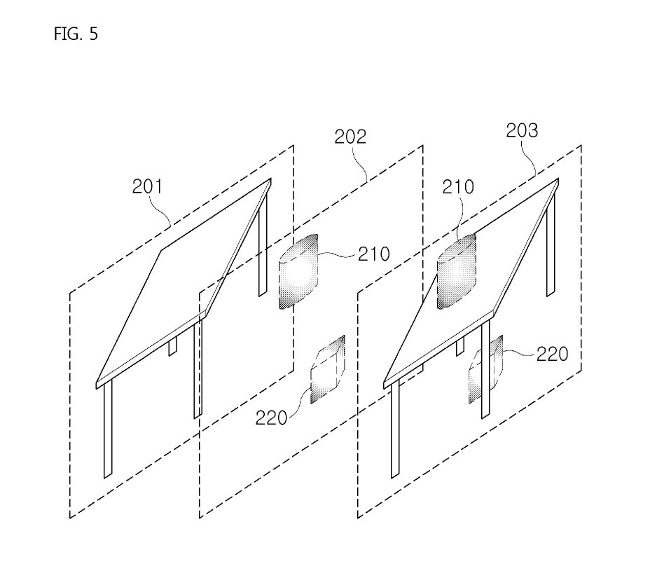

The mixed reality display device may display a final image 203 by using the color map 201 of the real object and the color map 205 of the virtual object shown in FIG. 5 generated through the above process. In this case, a part of the cube 220 of the virtual object is covered by the desk 200 of the real object, whereby the pixel of the corresponding part is not output and thus is output to the empty space.

While the present invention has been particularly shown and described with reference to exemplary embodiments thereof, it is to be understood that the present invention is not limited to the above-described embodiments, and various modifications and changes may be made thereto by those skilled in the art to which the present invention belongs. Accordingly, the spirit of the present invention should be understood only by the appended claims, and all equivalent or equivalent variations thereof are included in the scope of the present invention.

1. A mixed reality display device, comprising:
a virtual environment rendering unit generating a virtual object by using information on a scene in a virtual reality, and then generating a color map and a depth map of the virtual object;
a depth rendering unit generating a depth map of a real object by using information on a real environment;
an occlusion processing unit performing occlusion processing by using the color map and the depth map of the virtual object received from the virtual environment rendering unit, the depth map of the real object received from the depth rendering unit, and a color map of the real object received from a see-through camera; and
a display unit outputting a color image by using the color map of the virtual object received from the occlusion processing unit and the color map of the real object received from the see-through camera.

2. The device of claim 1, wherein the virtual environment rendering unit includes:
a virtual environment scene module providing a virtual environment configured to have information on the virtual object;
a rendering module performing rendering on the virtual object provided by the virtual environment scene module to generate the depth map and the color map of the virtual object during the rendering; and
a color/depth map providing module providing the depth map and the color map generated by the rendering module.

3. The device of claim 1, wherein the depth rendering unit includes:
a real object model module providing an object modeled in the same manner as the real object in the real environment;
an environment scan module scanning the real environment to generate a point cloud or a mesh model for the real object;
a depth rendering module performing depth rendering to generate the depth map by using the real object model received from the real object model module or the mesh model or the point cloud received from the environment scan module; and
a depth map providing module providing the depth map generated through the depth rendering in the depth rendering module.

4. The device of claim 3, wherein the depth rendering module maps each point of the point cloud to the pixel to generate the depth map immediately when the point cloud is received from the environment scan module.

5. The device of claim 3, wherein the depth rendering module configures a same scene as the real environment using the object modeled in the same manner as the real object received from the real object model module, generates the depth map using the scene, and tracks and predicts a position and rotation of a dynamic object to change the position and rotation in the depth rendering dynamically when a type of the real object is a dynamic object.

6. The device of claim 1, wherein the occlusion processing unit compares the depth map of the real object with the depth map of the virtual object on a per-pixel basis to check whether there is a pixel having a different depth, selects a pixel having a lower depth when a specific pixel has a different depth in the depth map of the real object and the depth map of the virtual object as a result of the checking, and displays a same pixel color as the corresponding position in the color map of the corresponding object.

7. The device of claim 1, wherein the occlusion processing unit generates an alpha map by using the depth map and color map of the virtual object received from the virtual environment rendering unit, the depth map of the real object received from the depth rendering unit, and the color map of the real object received from the see-through camera.

8. The device of claim 7, further comprising:
a synthesis processing unit outputting a pixel in the color map of the virtual object or a pixel in the color map of the real object received from the see-through camera according a mask value when a specific pixel format is a mask format in the alpha map received from the occlusion processing unit, and outputting a pixel in the color map of the virtual object and a pixel of the color map of the real object received from the see-through camera simultaneously according to an alpha value when a specific pixel format is an alpha format in the alpha map received from the occlusion processing unit.

9. The device of claim 8, wherein the synthesis processing unit outputs the pixel in the color map of the real object received from the see-through camera when the specific pixel format is the mask format in the alpha map received from the occlusion processing unit and the mask value is 0, and outputs the pixel of the color map of the virtual object received from the see-through camera when the specific pixel format is the mask format in the alpha map received from the occlusion processing unit and the mask value is 1.

10. The device of claim 8, wherein the synthesis processing unit performs blending calculation on the pixel in the color map of the real object received from the see-through camera and the pixel in the color map of the virtual object according to the alpha value when the specific pixel format is the alpha format in the alpha map received from the occlusion processing unit.
